(19) United States
(12) Patent Application Publication
(10) Pub. No.: US 2026/0191238 A1
(43) Pub. Date: Jul. 9, 2026

(54) RICE KOJI FERMENTED AND SACCHARIFIED LIQUID, AND MANUFACTURING METHOD THEREFOR

(71) Applicant: MEIJI CO., LTD., Tokyo (JP)

(72) Inventors: Atsushi KANDA, Tokyo (JP); Yoshitaka KAWAI, Tokyo (JP); Miho TAKAHASHI, Tokyo (JP)

(73) Assignee: MEIJI CO., LTD., Tokyo (JP)

(21) Appl. No.: 19/132,645

(22) PCT Filed: Nov. 27, 2023
(86) PCT No.: PCT/JP2023/042414

§ 371 Date: May 23, 2025

(30) Foreign Application Priority Data
Nov. 28, 2022 (JP) 2022-189224

(51) Int. Cl. A23L 7/104; A23L 2/52

(52) U.S. Cl. CPC A23L 7/104; A23L 2/52

(57) ABSTRACT

This invention provides a rice koji-fermented and saccharified grain liquid containing grain-derived β-glucan, a food or beverage containing the same, and a raw material for producing the food or beverage. The rice koji-fermented and saccharified grain liquid is characterized as follows:
(a) a weight average molecular weight of the grain-derived β-glucan is 100000 to 500000;
(b) a percentage of a grain-derived β-glucan with a molecular weight of 10000 or more to less than 800000 in a total 100 mass % of the grain-derived β-glucan is 80 mass % or more;
(c) a grain-derived β-glucan content in 100 mass % of solids of the rice koji-fermented and saccharified grain liquid is 1 to 35 mass %;
(d) an iodine coloration test result shows negative (−); and
(e) a viscosity is 10 to 5000 mPa·s.

### TECHNICAL FIELD

The present invention relates to a rice koji-fermented and saccharified grain liquid containing grain-derived β-glucan, a food or beverage containing the same, and a raw material for producing the food or beverage. The present invention also relates to a method of producing a rice koji-fermented and saccharified grain liquid containing grain-derived β-glucan.

### BACKGROUND ART

Grains such as oats and barley are widely used as ingredients in cereals and other food products because they are rich in water-soluble dietary fibers. Most of the water-soluble dietary fibers contained in grains are β-glucan. β-Glucan naturally found in grains (which is also referred to as “untreated β-glucan” herein) is a linear polymer compound consisting of glucose units that are polymerized through β-1,3 and β-1,4 bonds. β-Glucan has been reported to have various physiological functions such as normalizing blood cholesterol levels, suppressing the rise in blood glucose levels after meals, maintaining a feeling of fullness, enhancing the proliferation of bifidobacteria, and modulating the immune system. Due to the positive health image based on these physiological functions, the demand for grains as a food ingredient has been expanding in recent years.

Generally, oat β-glucan is said to have a molecular weight of 2000000 to 3000000, and barley β-glucan is said to have a molecular weight of 50000000. Untreated β-glucan has a high molecular weight and is thus highly viscous and poorly water soluble.

One known method of preventing or reducing such a thickening problem is a method in which a grain is ground, dissolved in water or the like, and then saccharified with enzymes such as amylase and cellulase to obtain a liquid form. This method is used to produce oat milk, because the natural sweetness is attained with saccharification. However, because β-glucan is completely degraded together with starch by enzyme treatment or because β-glucan is also removed when insoluble components are removed, a method is employed in which water-soluble dietary fibers that are low viscous and are easy to handle, such as inulin, are separately added as needed to complement physiological functions.

Recently proposed methods include a method of producing a saccharified grain product using β-glucan function, without completely degrading the β-glucan.

Specifically, Patent Literature 1 discloses a method of preparing a saccharified grain product. The method includes dispersing a β-glucan-containing ground grain in water; performing a protein degradation reaction using a protease proteolytic enzyme having a β-glucanase activity of 0 to 10% before performing a liquefaction reaction and a saccharification reaction; degrading starch by using a liquefying enzyme having a β-glucanase activity of 0 to 10% (β-amylase) and a saccharifying enzyme having a β-glucanase activity of 0 to 10% (β-amylase, glucoamylase); and performing solid-liquid separation to remove insoluble parts, whereby a saccharified grain product containing 1 to 15 mass % of β-glucan and showing negative (−) for an iodine coloration test is prepared.

In this method, it is essential to perform the protein degradation reaction before the enzymatic liquefaction reaction. According to the disclosure, if these reactions are not performed in this order, β-glucan will remain in the residue during solid-liquid separation, and the residue will be removed as an insoluble part. Thus, the resulting saccharified grain product will not have a sufficient β-glucan content.

Patent Literature 2 discloses a method of preparing a plant-derived β-glucan-containing syrup. The method includes subjecting a saccharified grain product prepared by enzyme treatments (protein degradation, enzymatic liquefaction, and enzymatic saccharification) similar to the methods disclosed in Patent Literature 1 to filtering using diatomaceous earth, activated charcoal, or the like; passing a liquid through a filter; and concentrating the liquid to a predetermined Brix value, whereby a plant-derived β-glucan-containing syrup is obtained in which a plant-derived β-glucan with a weight average molecular weight of 2,500 to 40,000 is present at a percentage of 2 to 8 mass % of the total soluble solids, the viscosity is 10,000 cP or less, and the Brix value is 30 to 80%.

Further, Patent Literature 3 states that a water-soluble β-glucan with a weight average molecular weight of 5000 to 100000, which is obtainable by reducing the molecular weight of β-glucan found in seeds of Poaceae plants such as barley and oats, has an immune enhancing effect. The molecular weight is reduced by, for example, hydrolysis by heating under pressure in the presence of acid or hydrolysis using enzymes such as β-glucanase.

As described above, conventionally, methods such as hydrolysis by heating under pressure and hydrolysis using enzymes have been suggested in production of saccharified grain products containing β-glucan. However, these methods require precise control in order to obtain a predetermined amount of β-glucan with a molecular weight reduced to a desired degree, without excessively degrading the β-glucan.

### CITATION LIST

### Patent Literature

PTL 1: JP2009-050226A
PTL 2: JP2020-054399A
PTL 3: JP2001-323001A

### Non-Patent Literature

NPL 1: The retrogradation kinetics of starches of different botanical origin in the presence of glucose syrup. International Journal of Biological Macromolecules Volume 114, 15 Jul. 2018, pages 1288-1294

### SUMMARY OF INVENTION

### Technical Problem

The present invention aims to provide a rice koji-fermented and saccharified grain product in a liquid form (rice koji-fermented and saccharified grain liquid) containing low molecular weight β-glucan derived from a grain. The present invention also aims to provide a method of producing the same. The present invention also aims to provide a food or beverage containing the rice koji-fermented and saccharified grain liquid or a processed product thereof, and a raw material for producing the food or beverage.

### Solution to Problem

As a result of extensive study to obtain, by a simple method, a grain-derived β-glucan-containing product that can be easily handled as a food or beverage or an ingredient thereof, the present inventors found that fermentation of a ground grain using rice koji allows liquefaction and saccharification reactions to proceed while allowing low molecular weight β-glucan to remain. As a result, the present inventors found that a saccharified liquid containing grain-derived β-glucan can be obtained that has easy-to-handle viscosity and good dispersion stability, while having a high β-glucan content with a molecular weight reduced to achieve a desired weight average molecular weight.

The present invention was completed through further studies based on the above findings, and has the following embodiments.

Herein, the description “A to B” (A and B are any numerical values) means “A or more and B or less” unless specifically mentioned otherwise.

### (I) Rice Koji-Fermented and Saccharified Grain Liquid Containing Grain-Derived β-Glucan

(I-1) A rice koji-fermented and saccharified grain liquid containing grain-derived β-glucan, which is characterized as follows:
   (a) a weight average molecular weight of the grain-derived β-glucan is 100000 to 500000, preferably 250000 to 500000;
   (b) a percentage of a grain-derived β-glucan with a molecular weight of 10000 or more to less than 800000 in a total 100 mass % of the grain-derived β-glucan is 80 mass % or more, preferably 80 to 98 mass %;
   (c) a grain-derived β-glucan content in 100 mass % of solids of the rice koji-fermented and saccharified grain liquid is 1 to 35 mass %, preferably 3 to 30 mass %;
   (d) an iodine coloration test result shows negative (−); and
   (e) a viscosity is 10 to 5000 mPa·s.
(I-2) The rice koji-fermented and saccharified grain liquid according to (I-1), wherein the grain-derived β-glucan is further characterized as follows:
   (f) a molecular weight (mode) is 10000 to 300000, preferably 80000 to 300000.
(I-3) The rice koji-fermented and saccharified grain liquid according to (I-1) or (I-2), which is characterized as follows:
   (A) a sediment amount per 100 mL volume is less than 10 mL; and
   (B) a flow time of a product having a mass of 100 g is less than 60 sec,
   wherein (A) and (B) above are measured by methods under conditions described in Test Methods (6) and (7) in the Examples.
(I-4) The rice koji-fermented and saccharified grain liquid according to any one of (I-1) to (I-3), wherein the grain is a seed of a Poaceae plant.
(I-5) The rice koji-fermented and saccharified grain liquid according to (I-4), wherein the Poaceae plant is at least one selected from oat and barley.
(I-6) The rice koji-fermented and saccharified grain liquid according to any one of (I-1) to (I-5), wherein the rice koji is Aspergillus oryzae.

### (II) Method of Producing Rice Koji-Fermented and Saccharified Grain Liquid Containing Grain-Derived β-Glucan

(II-1) A method of producing the rice koji-fermented and saccharified grain liquid according to any one of (I-1) to (I-6), the method comprising: heating a ground grain in the presence of water to completely or partially gelatinize starch; and fermenting the ground grain using rice koji.
(II-2) The production method according to (II-1), wherein a mixing ratio of the rice koji to 1 part by mass of β-glucan (untreated β-glucan) in the ground grain is 0.1 to 10 parts by mass, preferably 0.4 to 8.5 parts by mass.
(II-3) The production method according to (II-1) or (II-2), wherein the grain is a seed of a Poaceae plant.
(II-4) The production method according to any one of (II-1) to
(II-3), wherein the Poaceae plant is at least one selected from oat and barley, preferably oat.
(II-5) The production method according to any one of (II-1) to (II-4), wherein the rice koji is Aspergillus oryzae.

### (III) Food or Beverage or Raw Material for Producing the Food or Beverage

(III-1) A food or beverage containing the rice koji-fermented and saccharified grain liquid according to any one of (I-1) to (I-6) or a processed product thereof, or a raw material for producing the food or beverage.

### Advantageous Effects of Invention

The present invention can provide a fermented and saccharified grain liquid, which is low viscous and easy to handle and has good dispersion stability, while it has a desired high percentage of β-glucan with a molecular weight reduced to achieve a desired weight average molecular weight. The fermented and saccharified grain liquid of the present invention shows negative (−) for an iodine coloration test and contains no starch. Thus, thickening due to heating is prevented or reduced. Therefore, it is useful as a grain-derived β-glucan-containing food or beverage or as a raw material for producing the grain-derived β-glucan-containing food or beverage.

### DESCRIPTION OF EMBODIMENTS

### (I) Rice Koji-Fermented and Saccharified Grain Liquid Containing Grain-Derived β-Glucan

The rice koji-fermented and saccharified grain liquid contemplated by the present invention is a saccharified product in a liquid form that can be obtained by heating a grain in the presence of water to completely or partially gelatinize starch, and fermenting the ground grain using rice koji. The rice koji-fermented and saccharified grain liquid contains grain-derived β-glucan and is characterized as described in (a) to (e) below.
(a) a weight average molecular weight of the grain-derived β-glucan is 100000 to 500000;
(b) a percentage of a grain-derived β-glucan with a molecular weight of 10000 or more to less than 800000 in a total 100 mass % of the grain-derived β-glucan is 80 mass % or more;
(c) a grain-derived β-glucan content in 100 mass % of solids of the rice koji-fermented and saccharified grain liquid is 1 to 35 mass %;
(d) an iodine coloration test result shows negative (−); and
(e) a viscosity is 10 to 5000 mPa·s.

Hereinafter, the rice koji-fermented and saccharified grain liquid of the present invention is described.

Grains Any grain that contains β-glucan can be used as a raw material of the rice koji-fermented and saccharified grain liquid. However, a seed of a Poaceae plant is preferred. Examples of seeds of the Poaceae plants include seeds of rice, wheat, corn, sorghum, barnyard millet, foxtail millet, millet, barley, oats (Avena fatua, Avena sativa) and rye. Strains and varieties of the seeds of these Poaceae plants are not limited as long as they contain β-glucan. For example, rice has a non-glutinous rice strain and a glutinous rice strain, and both can be used as long as β-glucan is present. Barley has varieties such as two-row barley, four-row barley, six-row barley, and hulless barley, and any can be used as long as β-glucan is present. Grains having a high β-glucan content are preferred, and examples of such grains include barley and oats. Oats are more preferred because they allows for more effective achievement of the effect of the present invention, i.e., the obtainment of a rice koji-fermented and saccharified grain liquid in which the dispersion stability and handleability are good while the low molecular weight β-glucan content is high, as described later in the Examples.

As a raw material, any of the above-mentioned grains may be used alone or two or more thereof may be used in any combination.

The part of grain that can be used is any fraction of grains containing β-glucan, such as whole grains, processed grains, and bran. In barley, since the endosperm has a high β-glucan content, use of whole grains or polished grains containing the endosperm is preferred. In the case of oats, since the bran has a high β-glucan content, the use of whole oats containing bran and the use of bran itself are preferred. A more preferred ingredient is oat bran.

When used as a raw material of the rice koji-fermented and saccharified grain liquid, the grain is preferably ground (ground grain) in terms of saccharification efficiency. Generally, the degree of grinding is classified according to the particle size of the ground grain flour (grinding particle size) into coarse grinding (up to about 1 mm), medium grinding (from about 1 mm to about several tens of micrometers), fine grinding (from about several tens of micrometers to about 10 μm), and ultrafine grinding (about 10 μm or less). In the present invention, although it is not limited, the ground grain that can be used is preferably a ground grain having a medium grinding particle size or less, more preferably a ground grain having a medium grinding to fine grinding particle size (from about 1 mm to about 10 μm), particularly preferably a ground grain having a fine grinding particle size (from about several tens of micrometers to about 10 μm). The term “grinding particle size” as used herein refers to the median diameter.

### Grain-Derived β-Glucan

The grain-derived β-glucan contained in the rice koji-fermented and saccharified grain liquid of the present invention is a natural β-glucan (untreated β-glucan) naturally found in grains, with the molecular weight reduced by fermentation using rice koji. Among grains, the untreated β-glucan found in barley is said to have a molecular weight of 50000000, and the untreated β-glucan found in oats is said to have a molecular weight of 2000000 to 3000000.

The grain-derived β-glucan contained in the rice koji-fermented and saccharified grain liquid has a molecular weight distribution of about 1000 to 1600000, preferably about 1000 to 1200000, and a weight average molecular weight of 100000 to 500000. The lower limit of the weight average molecular weight is 100000, preferably 150000, more preferably 200000, still more preferably 250000. The upper limit of the weight average molecular weight 500000, preferably 450000, more preferably 400000. These lower limits and upper limits can be selected in any combination. Examples include the following ranges: 150000 to 500000, 200000 to 500000, 250000 to 500000, 150000 to 450000, 200000 to 450000, and 250000 to 450000.

The methods of determining the weight average molecular weight and molecular weight distribution (described below) of the grain-derived β-glucan contained in the rice koji-fermented and saccharified grain liquid are described in detail in the Examples.

In the molecular weight distribution of the grain-derived β-glucan, the percentage of a grain-derived β-glucan in the molecular weight range of 10000 or more to less than 800000 in the total 100 mass % of the grain-derived β-glucan in the rice koji-fermented and saccharified grain liquid is 80 mass % or more, preferably 80 to 98 mass % or 80 to 95 mass %, more preferably 85 to 95 mass %.

Similarly, in the molecular weight distribution of the grain-derived β-glucan, the percentages of grain-derived β-glucans within the respective molecular weight ranges are as follows:
10000 or more to less than 600000: 65 mass % or more, 70 mass % or more, preferably 75 to 95 mass %, more preferably 75 to 92 mass %;
10000 or more to less than 400000: 60 mass % or more, 65 mass % or more, preferably 65 to 85 mass %, more preferably 65 to 83 mass %;
10000 or more to less than 300000: 45 mass % or more, 50 mass % or more, preferably 55 to 80 mass %, more preferably 55 to 76 mass %; and
10000 or more to less than 200000: 27 mass % or more, 35 mass % or more, preferably 35 to 70 mass %, more preferably 38 to 67 mass %.

Although it is not limited, of all the molecular weights of grain-derived β-glucans contained in the rice koji-fermented and saccharified grain liquid, the most common molecular weight (mode) is 10000 to 300000. The lower limit of the molecular weight (mode) is 10000, preferably 20000, more preferably 30000, still more preferably 40000, particularly preferably 80000. The upper limit of the molecular weight (mode) is 300000, preferably 200000, more preferably 150000. These lower limits and upper limits can be selected in any combination. Examples include the following ranges: 10000 to 300000, 40000 to 300000, 80000 to 300000, and 10000 to 100000.

Based on such grain-derived β-glucan weight average molecular weight, molecular weight distribution, and molecular weight (mode), it is understood that the grain-derived β-glucan contained in the rice koji-fermented and saccharified grain liquid is a low molecular weight β-glucan generated by degradation of a high molecular weight untreated β-glucan.

The grain-derived β-glucan content per 100 mass % of solids of the rice koji-fermented and saccharified grain liquid is 1 to 35 mass %. The lower limit of the grain-derived β-glucan content is 1 mass %, preferably 2 mass %, more preferably 3 mass %, still more preferably 4 mass %. The upper limit thereof is 35 mass %, preferably 30 mass %, more preferably 29 mass %. These lower limits and upper limits can be selected in any combination. Examples include the following ranges: 1 to 30 mass %, 3 to 30 mass %, and 3 to 29 mass %. A preferred rice koji-fermented and saccharified grain liquid is a rice koji-fermented and saccharified grain liquid containing grain-derived β-glucan at a percentage as high as 20 to 30 mass %, particularly preferably 25 to 30 mass % within the numerical ranges described above, as described later in the Examples (Examples 4 to 7).

The β-glucan quantification method and the method of measuring the solids content of the rice koji-fermented and saccharified grain liquid are described in detail in the Examples.

### Rice Koji-Fermented and Saccharified Grain Liquid

The rice koji-fermented and saccharified grain liquid is a saccharified product in a liquid form obtained by heating a grain, preferably a ground product of the grain, in the presence of water and then fermenting using rice koji.

Thus, the saccharified liquid is characterized such that the starch naturally contained in the grain is degraded to a degree that the starch shows negative (−) in an “iodine coloration test.” The iodine coloration test method and its evaluation criteria are described in detail in the Examples.

The grain is heated in the presence of water to gelatinize the starch contained in the grain. When the starch contained in the grain is partially (not completely) or completely gelatinized in advance by the heating, the speed of action of enzymes such as α-amylase contained in rice koji can be increased in subsequent fermentation using the rice koji. The degree of gelatinization (gelatinization degree) of the starch by heating is not limited as long as the above-described object is not impaired. For example, it is in the range of 80 to 100%, preferably 90 to 100% (measurement method: glucoamylase method).

Heating method and heating conditions are not limited as long as the starch contained in the grain can be partially or completely gelatinized as described above. For example, in one method, a ground grain is heated in the presence of water at a temperature range of 50 to 90° C. for about 1 to 30 minutes. The heating may be performed under normal pressure (atmospheric pressure: 0.1 MPa) or under pressure. Preferred is a method in which a ground grain is heated in the presence of water under normal pressure at 60 to 85° C. for 5 to 20 minutes. More preferred heating temperature and time are 70 to 85° C. and 10 to 20 minutes, respectively. Presumably, a large amount or most of the starch in grain is gelatinized by heating under the above conditions (see Non-Patent Literature 1).

The rice koji for use in fermentation after the heating is prepared by adding koji mold to steamed rice and culturing under temperature and humidity conditions optimal for propagation. Strains of the koji mold include Aspergillus oryzae, Aspergillus sojae, Aspergillus kawachii, Aspergillus iuchuensis, the genus Monascus, and Aspergillus glaucus. Preferred are Aspergillus oryzae and Aspergillus sojae, and more preferred is Aspergillus oryzae. These types of rice koji are available on the market as raw materials for use in the production of miso, soy sauce, sake, shochu, awamori, red wine, dried bonito flakes, and the like, and are commercially available.

The rice koji is used at an amount in the range of 0.1 to 10 parts by mass per 100 parts by mass of β-glucan (untreated β-glucan) contained in a ground grain to be fermented. The lower limit of the amount of rice koji mixed is 0.1 parts by mass, preferably 0.4 parts by mass, more preferably 1 part by mass. The upper limit thereof is 10 parts by mass, preferably 8.5 parts by mass, more preferably 5 parts by mass. These lower limits and upper limits can be selected in any combination. Examples include the following ranges: 0.4 to 10 parts by mass, 0.4 to 8.5 parts by mass, 0.4 to 5 parts by mass, 1 to 8.5 parts by mass, and 1 to 5 parts by mass. The percentage of rice koji for use in fermentation is preferably adjusted as described above, whereby a rice koji-fermented and saccharified grain liquid containing a desired low molecular weight β-glucan with a desired weight average molecular weight and a desired molecular weight distribution can be obtained without excessively degrading the β-glucan contained in the ground grain.

The fermentation method using rice koji can be performed by cooling, in the presence of water, the ground grain that was heated (hereinafter also referred to as “heated ground grain”) to 50 to 70° C., seeding rice koji on the ground grain, and keeping it at a predetermined temperature for a predetermined time.

The percentage of the heated ground grain in the mixture (total raw materials) of water and the heated ground grain subjected to fermentation is not limited, but it is preferably 4 to 35 mass %, more preferably 4 to 30 mass %. As described above, the β-glucan content varies depending on a grain fraction used as a raw material. Thus, the percentage can be suitably adjusted according to the grain fraction. For example, when a fraction with a high β-glucan content (e.g., barley endosperm and oat bran) is used as a raw material, preferably, the percentage is selected from the range of 4 to 20 mass %, though not limited thereto. More preferably, the percentage is selected from the range of 4 to 10 mass %. When the whole grain of barley, oats, or the like is used as a raw material, preferably the percentage is selected from the range of 15 to 35 mass %, though not limited thereto. More preferably, the percentage is selected from the range of 15 to 30 mass %.

Fermentation conditions are not limited as long as the starch contained in the heated ground grain is degraded to a degree that evaluation of an “iodine coloration test” shows negative (−), and also as long as the untreated β-glucan in the ground grain is degraded to generate a saccharified product in a liquid form containing the above-described predetermined percentage of low molecular weight β-glucan with the above-described weight average molecular weight and molecular weight distribution.

For example, the temperature for fermentation is preferably 50 to 70° C., more preferably 55 to 65° C. The fermentation time needs to be appropriately adjusted according to the amount of ground grain used as a raw material, but usually, it is 1 hour or more, preferably 3 hours or more. The fermentation time has no upper limit, but is about 20 hours. Even when the fermentation time is somewhat long, the use of rice koji makes it possible to obtain a saccharified liquid containing low molecular weight β-glucan with a desired weight average molecular weight and a desired molecular weight distribution, without excessively degrading untreated β-glucan. In other words, the use of rice koji preferably at the above-described percentage eliminates the need for strict control of the fermentation time. Although not limited, the fermentation time may be in the range of 3 to 10 hours or 3 to 5 hours, for example.

Although not limited, the pH during fermentation is neutral, preferably 6.0 to 6.5. Fermentation may be performed under stirring or in a stationary state. Fermentation under stirring is preferred in terms of fermentation efficiency. Preferably, fermentation is performed in a dark place.

The rice koji can be used by itself for fermentation. However, a saccharifying enzyme may also be used in addition to the rice koji, and such use is not excluded, as long as the rice koji-fermented and saccharified grain liquid contemplated by the present invention can be obtained. Examples of saccharifying enzymes include β-amylase, pullulanase, isoamylase, and glucoamylase. Preferably, each of these saccharifying enzymes has a low β-glucanase activity (0 to 10% or less). In other words, in the present invention, the β-glucanase activity of a mixture prior to fermentation (mixture containing the heated ground grain and rice koji) is preferably 0 to 10% or less.

The β-glucanase activity is an enzyme activity that cleaves β-1,3 and β-1,4 bonds in β-glucan.

The β-glucanase activity of an enzyme sample can be measured by the following method.

A standard sample of untreated β-glucan is dissolved in pure water to a concentration of 5 mg/mL to produce a β-glucan aqueous solution. The enzyme sample is diluted with pure water to 5 mg/mL. The β-glucan aqueous solution and the diluted enzyme sample are mixed in a test tube. The mixture is incubated in a constant temperature bath at 50° C. for 14 hours, and then cooled on ice (enzyme mixture). The β-glucan with a molecular weight of 10⁵ or more in the enzyme mixture is measured by the Congo red method. Using a β-glucan aqueous solution (blank solution) mixed with pure water instead of the enzyme sample, the same procedure as above is performed to obtain a blank.

The β-glucanase activity is determined using the following formula.

$$β - Glucanase activity ( \% ) = ( 1 - B / {B}_{0} ) \times 100$$

$$B = β - glucan concentration in enzyme mixture$$

$${B}_{0} = β - glucan concentration in blank solution$$

Although not limited, the fermentation can be ended, for example, by heating the resulting saccharified liquid at 95° C. for 10 minutes, whereby a rice koji-fermented and saccharified grain liquid contemplated by the present invention can be obtained. The thus-obtained rice koji-fermented and saccharified grain liquid contains rice koji mold (dead fungus) as evidence of fermentation using rice koji, and the presence can be confirmed by genetic analysis or a usual method for detection of koji mold, such as detection of N-acetylglucosamine, which is a cell wall component.

The viscosity of the thus-obtained rice koji-fermented and saccharified grain liquid is preferably 10 to 5000 mPa·s. The lower limit of the viscosity is 10 mPa's, preferably 20 mPa·s, more preferably 25 mPa s. The upper limit is 5000 mPa·s, preferably 4500 mPa·s, more preferably 2000 mPa·s, still more preferably 1500 mPa·s. These lower limits and upper limits can be selected in any combination. Examples include the following ranges: 20 to 4500 mPa·s, 20 to 2000 mPa·s, and 25 to 1500 mPa·s.

The viscosity is measured at a temperature (internal temperature) of 10° C., using a rotational B-type viscometer (TVB10-type viscometer available from Toki Sangyo Co., Ltd.) and a rotor appropriate for the viscosity to be measured at a rotation speed of 60 rpm for a rotation time of 30 seconds. The detail is described in the Examples.

As described above, in the rice koji-fermented and saccharified grain liquid of the present invention, the starch is degraded to a degree that evaluation of an “iodine coloration test” shows negative (−). Thus, the viscosity does not significantly increase even under heating. Therefore, the rice koji-fermented and saccharified grain liquid of the present invention is advantageously easy to handle as a food or beverage or a raw material for producing the food or beverage.

The rice koji-fermented and saccharified grain liquid of the present invention has a pH in the range of 5.5 to 7.5, preferably 6.0 to 6.5.

### (II) Food or Beverage or Raw Material for Producing the Food or Beverage

The rice koji-fermented and saccharified grain liquid of the present invention described above can be used directly or in a processed state (a processed product) as a food or beverage or a raw material for producing the food or beverage.

Although not limited, the processing of the rice koji-fermented and saccharified grain liquid includes treatments such as adding and mixing edible components with the rice koji-fermented and saccharified grain liquid; diluting with water or other edible liquids; concentrating by evaporating water; removing insoluble matter by solid-liquid separation (e.g., centrifugation or filtration), drying (e.g., spray drying or freeze drying), grinding, and grain sizing. These treatments can be performed independently, or two or more treatments can be performed in any combination. The processed product of the rice koji-fermented and saccharified grain liquid of the present invention includes products obtained by processing the rice koji-fermented and saccharified grain liquid of the present invention with the above treatments.

Any edible component may be added to the rice koji-fermented and saccharified grain liquid, as long as it is an edible component, and it can be selected appropriately for the purpose. Examples include carbohydrates such as glucose, fructose, sucrose, maltose, starch syrup, and lactose; sugar alcohols such as sorbitol, erythritol, maltitol, and xylitol; high-intensity sweeteners such as aspartame, stevioside, sucralose, and acesulfame K; organic acids such as citric acid, tartaric acid, malic acid, succinic acid, and lactic acid; vitamins such as L-ascorbic acid, dl-α-tocopherol, B vitamins, nicotinamide, and calcium pantothenate; surfactants such as glycerol fatty acid esters, polyglycerol fatty acid esters, sucrose fatty acid esters, sorbitan fatty acid esters, and propylene glycol fatty acid esters; thickeners such as gum arabic, carrageenan, pectin, and agar; stabilizers such as casein and gelatin; amino acids; minerals such as calcium salts; and other additives that can be added to food and beverages such as sodium erythorbate, glycerol, propylene glycol, acidulants, pH adjusters, colorants, flavorings, and preservatives.

The “food or beverage” in the food or beverage or the raw material for producing the food or beverage is not limited. Examples include beverages such as soft drinks (e.g., fruit juice drinks, fruit drinks, carbonated drinks, vegetable drinks, coffee drinks, cocoa drinks, tea drinks, sports drinks, dairy drinks, jelly drinks, zenzai drinks, shiruko drinks, milkshakes, drinkable soups, and soy milk drinks), alcoholic drinks, non-alcoholic drinks, and lactic acid bacteria drinks; foods such as processed fruit products (jams, marmalades, syrups, and the like), processed grain products (bread, mochi, and the like), processed meat products (ham, sausage, and the like), dairy products (butter, cheese, yogurt, and the like), confectioneries (chocolate, cookies, cakes, jellies, and the like), and seasonings (soy sauce, sauce, mirin, and the like); and supplements.

In addition to the rice koji-fermented and saccharified grain liquid of the present invention, various components can be added to the above food or beverages and the above raw materials for producing the food or beverages, according to the type of the food or beverages. Examples include those mentioned above, such as carbohydrates, sugar alcohols, high-intensity sweeteners, organic acids, vitamins, surfactants, thickeners, stabilizers, amino acids, minerals, acidulants, pH adjusters, colorants, flavorings, preservatives, and other food or beverage ingredients.

The percentage of the rice koji-fermented and saccharified grain liquid or its processed product to be added to the food or beverage or the raw material for producing the food or beverage can be adjusted according to the type of the food or beverage or the raw material for producing the food or beverage and its usage and purpose. The percentage can be selected from the range of 0.01 to 100 mass %. Although it is not limited, in one embodiment, the rice koji-fermented and saccharified grain liquid or its processed product can be added in a percentage that allows the food or beverage or a raw material for producing the food or beverage to have a viscosity of 1000 mPa·s or less, preferably 20 to 200 mPa·s. The measurement conditions of the viscosity are as described above.

Herein, the terms “include” and “contain” and variations thereof mean “comprise,” “consist of” and “consist essentially of.”

### EXAMPLES

To facilitate understanding of the structure and effects of the present invention, the present invention is described below with reference to the Experimental Examples. However, these Experimental Examples are not intended to limit the present invention. The experiments described below were performed at room temperature (25±5° C.) under atmospheric pressure, unless otherwise mentioned. In the following, “%” means “mass %,” and “part(s)” means “part(s) by mass,” unless otherwise mentioned.

Ingredients and test methods used in the following Examples and Experimental Examples are as follows.

### Ingredients

Whole oat flour: finely ground oats with the husk removed; powder particle size (median diameter): 27 μm; untreated β-glucan content: 4 mass %, available from Naturex
Oat bran flour: finely ground oat bran with the outer husk (bran) removed; powder particle size (median diameter): 76 μm; untreated β-glucan content: 27.5 mass %, available from Naturex
Powdered rice koji 1: Aspergillus oryzae, available from Marukome Co., Ltd.
Powdered rice koji 2: Aspergillus oryzae, available from Tsurumiso Jyozou Co., Ltd.
Lichenase enzyme solution: lichenase (a specific, endo-β-(1-3) (1-4)-β-glucan 4 glucanohydrolase) suspension (Megazyme's β-Glucan Assay Kit (model number: K-BGLU) accessories)
0.1 M Phosphate buffer (pH: 6.5): mixture of a solution of 0.2 M sodium dihydrogen phosphate (27.6 g/L) and a solution of 0.2 M disodium hydrogen phosphate (53.6 g/L) at an arbitrary ratio, with the pH adjusted to 6.5
Sodium phosphate buffer (20 mM, pH 6.5): solution of sodium dihydrogen orthophosphate dihydrate (NaH₂PO₄·2H₂O) (3.12 g) in distilled water (900 mL), with the pH adjusted to 6.5 using 100 mM sodium hydroxide (4 g/L), and the volume adjusted to 1 L. 200 mM Acetate buffer (pH 4.0): mixture of glacial acetic acid (11.6 mL) and distilled water (900 mL), with the pH adjusted to 4. 0 by adding 1 M sodium hydroxide, and the volume adjusted to 1 L.
β-Glucosidase solution: Megazyme's β-Glucan Assay Kit (model number: K-BGLU) accessories
α-Amylase: product name “BAN 480L,” available from Novozymes Glucoamylase: product name “Amylase AG 300 L,” available from Novozymes

### Test Methods

### (1) β-Glucan Molecular Weight Distribution Measurement

β-Glucan is extracted from the target test sample. The extract is subjected to gel filtration high performance liquid chromatography to measure the molecular weight distribution of β-glucan in the test sample.

Specifically, the target test sample (1.5 g) is mixed with a 95% (v/v) ethanol-containing aqueous solution (4 g), and the mixture is centrifuged with a relative centrifugal force of 1800 G. The sediment obtained by the centrifugation is suspended in a 50% (v/v) ethanol-containing aqueous solution (4 g), and the suspension is again centrifuged with a relative centrifugal force of 1800 G. The sediment obtained by the centrifugation is dissolved in 0.1 M phosphate buffer (pH: 6.5) (3 g), kept at 50° C. for 5 minutes, and then centrifuged with a relative centrifugal force equivalent to 1000 G, whereby the supernatant is collected. The supernatant contains β-glucan. Then, the collected supernatant is diluted 2.5-fold in 0.1 M phosphate buffer (pH: 6.5). The resulting product is subjected to gel filtration high performance liquid chromatography under the following conditions. The β-glucan molecular weight distribution is determined from the resulting chromatogram.

### HPLC Conditions

HPLC system: Agilent Technologies 1200 Series Column: TSKgel G3000PWXL
Column temperature: 35° C.
Solvent: 0.1 M phosphate buffer (pH: 6.5)
Flow rate: 0.8 mL/min
Detector: RI detector G1362A (Agilent Technologies)
Detection temperature: 40° C.

### (2) β-Glucan Quantification

The β-glucan content of the test sample is measured using the McCleary method (enzymatic method) with “Megazyme's β-Glucan Assay Kit (model number: K-BGLU).”

Specifically, the following method is used for the measurement.

3 mL of a test sample is weighed into a test tube, boiled in a water bath for 5 minutes, and cooled to room temperature. A 95% (v/v) ethanol-containing aqueous solution (6 mL) is added and dispersed in the test sample, followed by centrifugation with a relative centrifugal force of 1800 G to obtain sediment. The collected sediment is suspended in a 50% (v/v) ethanol-containing aqueous solution (8 mL), followed by centrifugation with a relative centrifugal force of 1800 G to obtain sediment again. The collected sediment is suspended in a sodium phosphate buffer (20 mM, pH 6.5) (4.0 mL), and heated at 50° C. for 5 minutes.

A lichenase enzyme solution (0.2 mL) attached to the Megazyme's β-Glucan Assay Kit is added to the test tube containing the thus-prepared sample, and the mixture is reacted at 50° C. for 1 hour. Then, 200 mM acetate buffer (pH 4.0) (5 mL) is added and mixed together. The mixture is left to stand at room temperature for 5 minutes and centrifuged at a relative centrifugal force of 1800 G. The supernatant is collected in three test tubes (0.1 mL in each test tube). 50 mM acetate buffer (pH 4.0) (0.1 mL) is added to one test tube (for blank), and a β-glucosidase solution (0.1 mL) is added to each of the other two test tubes (for sample, n=2), followed by reaction at 50° C. for 10 minutes. Subsequently, a glucose oxidase/peroxidase solution (3 mL) (accessories of Megazyme's β-Glucan Assay Kit) is added to each test tube, followed by reaction at 50° C. for 20 minutes. Then, the absorbance of the sample (blank or sample) in each test tube at 510 nm is measured. Separately, the absorbance (EA) of the glucose oxidase/peroxidase solution (3 mL) containing 100 μg of glucose at 510 nm is measured.

The β-glucan content of the test sample is determined from these measurement results, using the following formula.

$$β - Glucan content ( \% , w / w ) = Δ A \times F \times 0.00276$$

$$Δ A = ( absorbance of sample ) - ( absorbance of blank )$$

$$F = ( 100 ) / ( absorbance of glucose 100 µg : EA )$$

### (3) Measurement of Solids Content of Test Sample (Sand Mixing Method)

The following method is used for the measurement.
(i) An aluminum weighing dish containing 15 to 20 g of silica sand and a small glass rod is dried for 1 hour in a hot air circulating dryer set at 102° C., and then allowed to cool in a desiccator for about 30 minutes.
(ii) The aluminum weighing dish (containing the silica sand and the small glass rod) dried in the above manner is weighed using a precision balance. Subsequently, 1.5 to 2.0 g of a test sample is placed in the dish, and the mass of the test sample is precisely weighed (sample mass).
(iii) The weighing dish containing the sample is heated on a hot plate, while the contents (the test sample, silica sand, and small glass rod) of the weighing dish are gently stirred with a glass rod.
(iv) Once the silica sand has become dry and loose, the weighing dish containing the test sample is placed in a hot air circulating dryer set at 102° C. for 2 hours to dry, and then allowed to cool in a desiccator for about 30 minutes.
(v) The weighing dish containing the test sample prepared above is weighed on a precision balance, and the solids content (mass %) of the test sample is calculated from the mass (dry mass) of the test sample, using the following formula.

$$Solids content [ mass \% ] = 100 - \{ ( [ sample mass - dry mass ] / sample mass ) \times 100 \}$$

### (4) Iodine Coloration Test

The test was performed based on the description of “Denpun Kagaku Jikkenho [Starch Science Experimental Method]” (edited by Shigeo Suzuki and Michinori Nakamura, Asakura-shoten, 1979).

Specifically, a target test sample was prepared to have a solids content of 10, which was then mixed with a 0.01 M iodine solution and left to stand at room temperature. After 5 minutes, the coloration was visually checked. The 0.01 M iodine solution was prepared by dissolving 12.7 g of iodine and 40 g of potassium iodide in 25 mL of pure water and further diluting the solution 5-fold with pure water.

The coloration is evaluated as follows: yellow is (−); blue is (+3); and the range between “yellow” (−) and “blue” (+3) is (+1) or (+2) depending on the degree of blue.

### (5) Viscosity Measurement

The viscosity is measured at a temperature of 10° C., using a rotational B-type viscometer (TVB10 type viscometer available from Toki Sangyo Co., Ltd.). Specifically, 100 mL of the target test sample (internal temperature: 10° C.) is placed in a predetermined measurement container (shape: tall beaker; size: 100 mL), and a rotor selected from various types (No. 1: 10 to 100 mPa·s; No. 2: 100 to 500 mPa·s; No. 3: 500 to 2000 mPa·s; and No. 4: 2000 to 10000 mPa·s) according to the viscosity of the test sample is placed in the container, and the value measured after rotation (at 60 rpm for 30 seconds) is regarded as the viscosity.

### (6) Sediment Amount (mL) Per 100 mL of Test Sample

50 mL portions of 100 mL of the target test sample are separately placed in two 50 mL graduated centrifuge tubes, and centrifuged at 25° C. with a relative centrifugal force of 480 G for 10 minutes. The total amount (mL) of colored sediment in the two centrifuge tubes is regarded as the sediment amount (mL) per 100 mL of the test sample.

The sediment amount of each test sample was evaluated according to the following criteria, and the results were used for evaluation of dispersion stability of the test sample.
A: Sediment amount: less than 10 mL/100 mL
B: Sediment amount: 10 mL or more and less than 15 mL/100 mL
C: Sediment amount: 15 mL or more/100 mL
   (7) Liquidity of Test Sample (Time Required for Flow [sec])

The test sample (100 g) with the internal temperature adjusted to 25° C. was placed on a plastic funnel, and the time required for the entire amount to flow out was measured and regarded as the “flow time (sec).”

Specifically, 100 g of the test sample was placed in the funnel with the tip of the funnel's tube (stem) closed, and then the tip was opened with the tip facing vertically downward. The time from when the test sample started to flow out to when it finished was measured.

The plastic funnel used had a conical opening diameter of 8 am, an angle of 60 degrees, a tube inner diameter of 1 cm, and a tube length of 2 cm.

The liquidity of the test sample was evaluated according to the following criteria.
A: Flow time: less than 60 sec
B: Flow time: 60 sec or more and less than 300 sec
C: Flow time: 300 sec or more

### (8) Comprehensive Evaluation of Sediment Amount and Liquidity of Test Sample

Based on the sediment amount and liquidity of each test sample measured in (6) and (7) above, the dispersion stability and handleability of each test sample were comprehensively evaluated according to the following criteria.

### [Comprehensive Evaluation of Dispersion Stability and Handleability]

AA: Both sediment amount and liquidity are rated A.
A: One of sediment amount and liquidity is rated A, and the other is rated B.
B: Both sediment amount and liquidity are rated B; or one of them is rated C and the other is rated A.
C: Both sediment amount and liquidity are rated C; or one of them is rated C and the other is rated B.

### Example 1

Whole oat flour (150 g) was mixed with water (800 g). While heating at 85° C. for 10 minutes under stirring, the starch contained in the whole oat flour was partially or completely gelatinized. Subsequently, the resulting product was cooled, and when the temperature reached 55° C., the powdered rice koji 1 (50 g) was added. The mixture (pH: about 6) was fermented under stirring for 3 hours under dark conditions at 55° C. Then, the mixture was heated at 95° C. for 10 minutes for sterilization, whereby an oat-derived rice koji-fermented and saccharified liquid 1 was obtained.

### Example 2

Whole oat flour (150 g) was mixed with water (800 g). While heating at 85° C. for 10 minutes under stirring, the starch contained in the whole oat flour was partially or completely gelatinized. Subsequently, the resulting product was cooled, and when the temperature reached 55° C., the powdered rice koji 2 (50 g) was added. The mixture (pH: about 6) was fermented under stirring for 3 hours under dark conditions at 55° C. Then, the mixture was heated at 95° C. for 10 minutes for sterilization, whereby an oat-derived rice koji-fermented and saccharified liquid 2 was obtained.

### Example 3

Whole oat flour (300 g) was mixed with water (600 g). While heating at 85° C. for 10 minutes under stirring, the starch contained in the whole oat flour was partially or completely gelatinized. Subsequently, the resulting product was cooled, and when the temperature reached 55° C., the powdered rice koji 1 (100 g) was added. The mixture (pH: about 6) was fermented under stirring for 3 hours under dark conditions at 55° C. Then, the mixture was heated at 95° C. for 10 minutes for sterilization, whereby an oat-derived rice koji-fermented and saccharified liquid 3 was obtained.

### Example 4

Oat bran flour (40 g) was mixed with water (945 g). While heating at 85° C. for 10 minutes under stirring, the starch contained in the oat bran flour was partially or completely gelatinized. Subsequently, the resulting product was cooled, and when the temperature reached 55° C., the powdered rice koji 1 (15 g) was added. The mixture (pH: about 6) was fermented under stirring for 3 hours under dark conditions at 55° C. Then, the mixture was heated at 95° C. for 10 minutes for sterilization, whereby an oat-derived rice koji-fermented and saccharified liquid 4 was obtained.

### Example 5

Oat bran flour (40 g) was mixed with water (945 g). While heating at 85° C. for 10 minutes under stirring, the starch contained in the oat bran flour was partially or completely gelatinized. Subsequently, the resulting product was cooled, and when the temperature reached 55° C., the powdered rice koji 1 (15 g) was added. The mixture (pH: about 6) was fermented under stirring for 5 hours under dark conditions at 55° C. Then, the mixture was heated at 95° C. for 10 minutes for sterilization, whereby an oat-derived rice koji-fermented and saccharified liquid 5 was obtained.

### Example 6

Oat bran flour (40 g) was mixed with water (940 g). While heating at 85° C. for 10 minutes under stirring, the starch contained in the oat bran flour was partially or completely gelatinized. Subsequently, the resulting product was cooled, and when the temperature reached 55° C., the powdered rice koji 1 (20 g) was added. The mixture (pH: about 6) was fermented under stirring for 5 hours under dark conditions at 55° C. Then, the mixture was heated at 95° C. for 10 minutes for sterilization, whereby an oat-derived rice koji-fermented and saccharified liquid 6 was obtained.

### Example 7

Oat bran flour (40 g) was mixed with water (955 g). While heating at 85° C. for 10 minutes under stirring, the starch contained in the oat bran flour was partially or completely gelatinized. Subsequently, the resulting product was cooled, and when the temperature reached 55° C., the powdered rice koji 1 (5 g) was added. The mixture (pH: about 6) was fermented under stirring for 2 hours under dark conditions at 55° C. Then, the mixture was heated at 95° C. for 10 minutes for sterilization, whereby an oat-derived rice koji-fermented and saccharified liquid 7 was obtained.

### Comparative Example 1

Whole oat flour (150 g) was mixed with water (850 g). While heating at 85° C. for 10 minutes under stirring, the starch contained in the whole oat flour was partially or completely gelatinized. Subsequently, the resulting product was cooled, and when the temperature reached 55° C., α-amylase (available from Novozymes) (0.2 g) and glucoamylase (available from Novozymes) (0.2 g) were added. The mixture (pH: about 6) was enzymatically treated under stirring for 3 hours under dark conditions at 55° C. Then, the mixture was heated at 95° C. for 10 minutes for sterilization, whereby an oat-derived enzyme-treated saccharified liquid A was obtained.

### Comparative Example 2

Whole oat flour (300 g) was mixed with water (698 g). While heating at 85° C. for 10 minutes under stirring, the starch contained in the whole oat flour was partially or completely gelatinized. Subsequently, the resulting product was cooled, and when the temperature reached 55° C., α-amylase (available from Novozymes) (1 g) and glucoamylase (available from Novozymes) (1 g) were added. The mixture (pH: about 6) was enzymatically treated under stirring for 3 hours under dark conditions at 55° C. Then, the mixture was heated at 95° C. for 10 minutes for sterilization, whereby an oat-derived enzyme-treated saccharified liquid B was obtained.

### Comparative Example 3

Oat bran flour (50 g) was mixed with water (950 g). While heating at 85° C. for 10 minutes under stirring, the starch contained in the oat bran flour was partially or completely gelatinized. Subsequently, the resulting product was cooled, and when the temperature reached 55° C., α-amylase (available from Novozymes) (0.2 g) and glucoamylase (available from Novozymes) (0.2 g) were added. The mixture (pH: about 6) was enzymatically treated under stirring for 3 hours under dark conditions at 55° C. Then, the mixture was heated at 95° C. for 10 minutes for sterilization, whereby an oat-derived enzyme-treated saccharified liquid C was obtained.

### Comparative Example 4

Whole oat flour (150 g) was mixed with water (850 g), and the mixture was heated at 95° C. for 10 minutes for sterilization, whereby an oat solution 1 were obtained.

### Comparative Example 5

Oat bran flour (50 g) was mixed with water (950 g), and the mixture was heated at 95° C. for 10 minutes for sterilization, whereby an oat solution 2 were obtained.

### Experimental Example 1

For each of the oat-derived rice koji-fermented and saccharified liquids 1 to 7 (Examples 1 to 7), the oat-derived enzymatically fermented and saccharified liquids A to C (Comparative Examples 1 to 3), and the oat solutions 1 to 2 (Comparative Examples 4 and 5), which were prepared by the methods described above, the β-glucan molecular weight distribution, β-glucan content, solids content, iodine coloration, viscosity, sediment amount, and liquidity were measured to obtain measured values.

Table 1 shows the molecular weight distribution, weight average molecular weight, and molecular weight (mode) of the β-glucan in Examples 1 to 7 and Comparative Examples 1 to 5. Table 2 and Table 3 summarize the measurement results of Examples 1 to 7 and Comparative Examples 1 to 5.

TABLE 1

| | Example | Example | Example | Example | Example | Example | Example |
|---|---|---|---|---|---|---|---|
| Molecular weight | 1 | 2 | 3 | 4 | 5 | 6 | 7 |
| 1600000 or more | — | — | — | — | — | — | 0.3 |
| 1200000 or more and | — | — | — | — | — | — | 3.4 |
| less than 1600000 | | | | | | | |
| 800000 or more and | 8.3 | 3.9 | — | 2.2 | 8.2 | 4.2 | 16.0 |
| less than 1200000 | | | | | | | |
| 600000 or more and | 12.1 | 2.9 | — | 6.3 | 5.1 | 8.4 | 13.2 |
| less than 800000 | | | | | | | |
| 400000 or more and | 9.0 | 5.2 | 4.1 | 15.7 | 12.3 | 3.3 | 19.5 |
| less than 600000 | | | | | | | |
| 300000 or more and | 7.8 | 6.6 | 5.9 | 17.7 | 14.8 | 12.7 | 9.9 |
| less than 400000 | | | | | | | |
| 200000 or more and | 9.4 | 9.5 | 6.7 | 18.5 | 17.4 | 14.9 | 9.3 |
| less than 300000 | | | | | | | |
| 100000 or more and | 14.1 | 15.1 | 10.6 | 21.2 | 21.6 | 16.7 | 5.4 |
| less than 200000 | | | | | | | |
| 50000 or more and | 14.8 | 17.7 | 11.1 | 16.5 | 17.8 | 20.1 | 22.7 |
| less than 100000 | | | | | | | |
| 30000 or more and | 14.1 | 16.5 | 28.5 | 1.8 | 2.7 | 17.0 | 0.0 |
| less than 50000 | | | | | | | |
| 10000 or more and | 6.5 | 17.0 | 28.4 | — | 0.05 | 2.5 | 0.0 |
| less than 30000 | | | | | | | |
| Less than 10000 | 4.1 | 5.5 | 4.8 | — | — | 0.1 | 0.1 |
| Weight average | 293962 | 174865 | 103507 | 295701 | 313334 | 368506 | 487404 |
| molecular | | | | | | | |
| weight (Mw) | | | | | | | |
| Molecular | 41940 | 12940 | 18350 | 100580 | 80580 | 84900 | 287502 |
| weight (mode) | | | | | | | |

| | Comparative | Comparative | Comparative | Comparative | Comparative |
|---|---|---|---|---|---|
| Molecular weight | Example 1 | Example 2 | Example 3 | Example 4 | Example 5 |
| 1600000 or more | — | — | — | 11.1 | 5.3 |
| 1200000 or more and | — | — | — | 30.9 | 22.3 |
| less than 1600000 | | | | | |
| 800000 or more and | — | — | — | 29.4 | 28.3 |
| less than 1200000 | | | | | |
| 600000 or more and | — | — | — | 11.6 | 13.5 |
| less than 800000 | | | | | |
| 400000 or more and | — | — | — | 7.5 | 11.3 |
| less than 600000 | | | | | |
| 300000 or more and | — | — | — | 3.7 | 6.6 |
| less than 400000 | | | | | |
| 200000 or more and | — | — | | 2.4 | 4.8 |
| less than 300000 | | | | | |
| 100000 or more and | — | — | — | 2.1 | 4.5 |
| less than 200000 | | | | | |
| 50000 or more and | — | — | — | 1.3 | 3.2 |
| less than 100000 | | | | | |
| 30000 or more and | — | — | | 0.05 | 0.2 |
| less than 50000 | | | | | |
| 10000 or more and | — | — | — | — | — |
| less than 30000 | | | | | |
| Less than 10000 | — | — | — | — | — |
| Weight average | — | — | — | 1067933 | 885895 |
| molecular | | | | | |
| weight (Mw) | | | | | |
| Molecular | — | — | — | 1282049 | 1046134 |
| weight (mode) | | | | | |

In the table, “—” means undetectable (absent).

TABLE 2

| | Example 1 | | Example 2 | | Example 3 | | Example 4 | | Example 5 | | Example 6 | | Example 7 | |
|---|---|---|---|---|---|---|---|---|---|---|---|---|---|---|
| Grain ingredient | Whole oat | | Whole oat | | Whole oat | | Oat bran | | Oat bran | | Oat bran | | Oat bran | |
| | flour 15% | | four 15% | | flour 30% | | flour 4% | | flour 4% | | flour 4% | | flour 4% | |
| Rice koji used | Powdered | | Powdered | | Powdered | | Powdered | | Powdered | | Powdered | | Powdered | |
| | rice koji 1 | | rice koji 2 | | rice koji 1 | | rice koji 1 | | rice koji 1 | | rice koji 1 | | rice koji 1 | |
| | (Aspergillus | | (Aspergillus | | (Aspergillus | | (Aspergillus | | (Aspergillus | | (Aspergillus | | (Aspergillus | |
| | oryzae) | | oryzae) | | oryzae) | | oryzae) | | oryzae) | | oryzae) | | oryzae) | |
| Amount of rice koji added (g/100 g) | 5 | | 5 | | 10 | | 1.5 | | 1.5 | | 2 | | 0.5 | |
| Untreated β-glucan content (g/100 g) | 0.6 | | 0.6 | | 1.2 | | 1.1 | | 1.1 | | 1.1 | | 1.1 | |
| before rice koji fermentation | | | | | | | | | | | | | | |
| Amount of rice koji added per gram | 8.33 | | 8.33 | | 8.33 | | 1.36 | | 1.36 | | 1.82 | | 0.45 | |
| of untreated β-glucan | | | | | | | | | | | | | | |
| Fermentation time | 3 hours | | 3 hours | | 3 hours | | 3 hours | | 5 hours | | 3 hours | | 2 hours | |
| Weight average molecular weight | 293962 | | 174865 | | 103507 | | 295701 | | 313334 | | 368506 | | 487404 | |
| (Mw) | | | | | | | | | | | | | | |
| Molecular weight (mode) | 41940 | | 12940 | | 18350 | | 100580 | | 80580 | | 84900 | | 287502 | |
| Viscosity (mPa · s) | 124 | | 105 | | 4,340 | | 38 | | 29 | | 32 | | 1,096 | |
| Iodine coloration test | — | | — | | — | | — | | — | | — | | — | |
| Grain-derived β-glucan content | 0.75 | | 0.49 | | 1.42 | | 1.15 | | 1.10 | | 1.12 | | 1.06 | |
| (g/100 mL) | | | | | | | | | | | | | | |
| Grain-derived β-glucan content | 5.0 | | 3.3 | | 4.7 | | 28.8 | | 27.5 | | 28.0 | | 26.5 | |
| relative to total solids (mass %) | | | | | | | | | | | | | | |
| Sediment amount (mL) per 100 mL | 11 | (B) | 11 | (B) | 0 | (A) | 8 | (A) | 8 | (A) | 8 | (A) | 8 | (A) |
| Flow time (sec) of 100 g | 5> | (A) | 5> | (A) | 120 | (A) | 5> | (A) | 5> | (A) | 5> | (A) | 5> | (A) |

| | | | | | | | |
|---|---|---|---|---|---|---|---|
| Comprehensive evaluation of | A | A | A | AA | AA | AA | AA |
| sediment amount and flow time | | | | | | | |

TABLE 3

| | Comparative | Comparative | Comparative | Comparative | Comparative |
|---|---|---|---|---|---|
| | Example 1 | Example 2 | Example 3 | Example 4 | Example 5 |
| Grain ingredient | Whole oat | Whole oat | Oat bran | Whole oat | Oat bran |
| | flour 15% | flour 30% | flour 5% | flour 15% | flour 5% |
| Rice koji used | α-Amylase | α-Amylase | α-Amylase | None | None |
| | Glucoamylase | Glucoamylase | Glucoamylase | | |
| Fermentation time | 3 hours | 3 hours | 3 hours | — | — |
| Weight average molecular weight (Mw) | N.D. | N.D. | N.D. | 1081191 | 912065 |
| Molecular weight (mode) | N.D. | N.D. | N.D. | 1282049 | 1046134 |
| Viscosity (mPa · s) | 54 | 160 | 8.4 | 50000 or more | 50000 or more |
| Iodine coloration test | — | — | — | +3 | +3 |
| Grain-derived β-glucan content (g/100 mL) | 0.02 | 0.07 | 0.02 | 0.80 | 1.12 |
| Grain-derived β-glucan content relative to | 0.1 | 0.2 | 0.5 | 5.3 | 28.0 |
| total solids (mass %) | | | | | |
| Sediment amount (mL) per 100 mL | 31 | 17 | 19 | 0 | 0 |
| | (C) | (C) | (C) | (A) | (A) |
| Flow time (sec) of 100 g | 5> | 5> | 5> | 600< | 600< |
| | (A) | (A) | (A) | (C) | (C) |
| Comprehensive evaluation of sediment | B | B | B | B | B |
| amount and flow time | | | | | |

As shown in Tables 1 to 3, the grain-derived β-glucan content of each saccharified liquid was confirmed to fall under the following ranges, when the saccharified liquid was obtained by heating the ground grain in the presence of water to gelatinize a large amount or most of the starch and then performing fermentation using rice koji to degrade the starch to a degree that evaluation of an “iodine coloration test” showed negative (−):
(a) weight average molecular weight of the grain-derived β-glucan: 100000 to 500000;
(b) percentage of a grain-derived β-glucan with a molecular weight of 10000 or more to less than 800000 in a total 100 mass % of the grain-derived β-glucan: 80 mass % or more, specifically 80 to 98 mass %; and
(c) a grain-derived β-glucan content in 100 mass % of solids of the rice koji-fermented and saccharified grain liquid is 1 to 35 mass %, specifically 3 to 30 mass %.

The saccharified liquid (internal temperature: 10° C.) also had a relatively low viscosity, i.e., 10 to 5000 mPa·s, specifically, 100 to 4500 mPa·s, and the viscosity was confirmed not to significantly increase even under heating.

Further, each of these oat-derived rice koji-fermented and saccharified liquids 1 to 7 had good handleability with a low viscosity and good liquidity, while having good dispersion stability at the same time. In particular, in each of the oat-derived rice koji-fermented and saccharified liquids 4 to 7, the percentage of the low molecular weight oat-derived β-glucan was as high as 25 to 30 mass % of the total solids, while the viscosity was relatively low, the liquidity was good, and the dispersion stability was also good.

These results show that the seeding amount of rice koji with respect to the heated ground grain is preferably adjusted in the range of 0.4 to 8.5 parts by mass, preferably 0.45 to 8.3 parts by mass, per part by mass of β-glucan (untreated β-glucan) contained in the grain.

In contrast, when the ground grain heated under the same conditions described above was treated with enzymes (α-amylase and glucoamylase) instead of rice koji, the results confirmed that the β-glucan contained in the grain was completely degraded and was hardly present in the resulting saccharified liquid.

1. A rice koji-fermented and saccharified grain liquid containing grain-derived β-glucan, which is characterized as follows:
(a) a weight average molecular weight of the grain-derived β-glucan is 100000 to 500000;
(b) a percentage of a grain-derived β-glucan with a molecular weight of 10000 or more to less than 800000 in a total 100 mass % of the grain-derived β-glucan is 80 mass % or more;
(c) a grain-derived β-glucan content in 100 mass % of solids of the rice koji-fermented and saccharified grain liquid is 1 to 35 mass %;
(d) an iodine coloration test result shows negative (−); and
(e) a viscosity is 10 to 5000 mPa s.

2. The rice koji-fermented and saccharified grain liquid according to claim 1, wherein the grain-derived β-glucan is further characterized as follows:
(f) a molecular weight (mode) is 10000 to 300000.

3. rice koji-fermented and saccharified grain liquid according to claim 1, wherein the grain is a seed of a Poaceae plant.

4. The rice koji-fermented and saccharified grain liquid according to claim 3, wherein the Poaceae plant is at least one selected from oat and barley.

5. The rice koji-fermented and saccharified grain liquid according to claim 1, wherein the rice koji is Aspergillus oryzae.

6. A method of producing the rice koji-fermented and saccharified grain liquid according to claim 1, the method comprising:
heating a ground grain in the presence of water to completely or partially gelatinize starch; and
fermenting the ground grain using rice koji.

7. The production method according to claim 6, wherein a mixing ratio of the rice koji to 1 part by mass of β-glucan in the ground grain is 0.1 to 10 parts by mass.

8. The production method according to claim 6, wherein the grain is a seed of a Poaceae plant.

9. The production method according to claim 8, wherein the Poaceae plant is at least one selected from oat and barley.

10. The production method according to claim 6, wherein the rice koji is Aspergillus oryzae.

11. A food or beverage comprising the rice koji-fermented and saccharified grain liquid according to claim 1 or a processed product thereof, or a raw material for producing the food or beverage.
